(19) United States
(12) Patent Application Publication
(10) Pub. No.: US 2025/0050532 A1
(43) Pub. Date: Feb. 13, 2025

(54) CLAMP FOR LIMITING CRACKS IN LOGS

(71) Applicant: Latschbacher GmbH, Kronstorf (AT)

(72) Inventor: Klaus LATSCHBACHER, Kronstorf (AT)

(21) Appl. No.: 18/798,126

(22) Filed: Aug. 8, 2024

(30) Foreign Application Priority Data
Aug. 11, 2023 (EP) 23191130.6

(51) Int. Cl. B27M 1/00

(52) U.S. Cl. CPC B27M 1/003

(57) ABSTRACT

Clamp for limiting cracks in logs, having two blades which each extend from a back surface to a cutting edge along a cutting direction and which are tapered in the cutting direction, the cutting directions of the two blades are aligned parallel to one another and wherein the two blades are connected by a first connecting bar which extends between first end regions of the two blades and by a second connecting bar which extends between second end regions of the two blades.

The invention relates to a clamp for limiting cracks in logs.

EP 3 287 647 A1 discloses a clamp for logs, having a base body on which at least three spaced-apart retaining tongues are formed, wherein the base body and the retaining tongues are aligned as blades in a common cutting direction, and wherein at least two latching lugs are formed on the base body and/or on at least one retaining tongue for a releasable connection to a setting tool.

### SUMMARY OF THE INVENTION

The task of the invention is to provide a clamp which can also be used with logs having a high density of the wood.

This task is solved for a clamp of the type as mentioned above in that the clamp has two blades which each extend from a back surface to a cutting edge along a cutting direction and which are tapered in the cutting direction, wherein the cutting directions of the two blades are aligned parallel to one another and wherein the two blades are connected, in particular exclusively, by a first connecting bar which extends between first end regions of the two blades and by a second connecting bar which extends between second end regions of the two blades.

The cutting direction refers to the direction in which the blade can be driven into a log with the least resistance. The two blades are connected to one another via the first and second connecting bars in such a way that their cutting directions are aligned parallel to one another, so that the least possible resistance can also be ensured for the two blades during a driving process into a log. It is preferable that first end regions of the two blades are connected, in particular exclusively, by a first connecting bar and that second end regions of the two blades are connected, in particular exclusively, by a second connecting bar. The fact that the blades are connected only at their respective end regions ensures that the two blades may deform freely elastically or elastically and plastically during the driving-in process in a central section between the respective first and second end region. This free deformation ensures advantageous adaptation of the blades to the conditions on the log, which does not necessarily have a homogeneous density in the area into which the clamp is to be driven. In addition, the exclusive connection of the two blades remote from the central section, which central section is located between the two end regions, allows independent elastic or elastic and plastic deformation of each of the blades after driving the clamp into the log. This possibility for deformation of the two blades is of particular interest if a crack in the log that is bridged by the clamp enlarges, for example due to drying out of the log. In this case, an individual geometric adaptation of the respective central section of the two blades favors a homogeneous load application from the log to the respective blade, so that local overloading of the blades can be at least largely avoided.

It is preferable that the first connecting bar and the second connecting bar each extend over a fraction of the total length of the respective blade. It is particularly preferred that this fraction is not greater than 25 percent, in particular not greater than 20 percent. This ensures that the blade has the possibility to deform freely over at least a fraction of 50 percent or more.

The blade can be tapered over its entire extension along the cutting direction, resulting in an essentially wedge-shaped profile for the blade in a cross-sectional plane that includes the cutting direction. Alternatively, starting from the back surface, the blade extends over an amount of 50 to 80 percent of a distance between the back surface and the cutting edge along the cutting length with a constant thickness and only tapers in an area adjacent to the cutting edge.

Advantageous further embodiments of the invention are the subject of the subclaims.

It is advantageous if the first connecting bar and the second connecting bar each extend between the back surfaces of the two blades. Preferably, it is provided that the first connecting bar has a first rear face and the second connecting bar has a second rear face, which together with the back surfaces of the two blades form a common surface. It is further provided that both the first connecting bar and the second connecting bar extend from the respective first face or second rear face along the cutting direction, this extension being only a fraction of a distance between the rear surface and the cutting edge.

Preferably, this fraction lies in an interval between 30 and 50 percent in relation to the distance between the back surface and the cutting edge.

It is advantageous if the two blades have a curvature with a radius of curvature in a cross-sectional plane aligned transversely to the cutting direction that is 5 to 10 times greater than a distance between the back surface and the cutting edge. In the application situation for the clamp, crack propagation in an end face of a log is to be prevented, with the clamp spanning an existing crack or a zone in which a crack is to be expected. If a crack expands, for example due to a drying process of the log, a distance between the first end regions of the blades and the second end regions of the blades is increased. As the two blades are each curved between the two opposite end regions, the radius of curvature of the two blades increases, as a kind of stretching process takes place for the two blades in the cross-sectional plane aligned transverse to the cutting direction. This stretching process creates a resulting force effect aligned in the radial direction of the respective curvature, which is exerted by the respective blade on the surrounding wood of the log, whereby a supporting effect occurs between the respective blade and the log, which in turn leads to an increase in the reaction forces provided by the clamp to the log. Accordingly, the curvature of the two blades ensures an improvement in the stabilizing effect that can be exerted by the clamp assembly on the log without requiring a significant additional effort in terms of the amount of material used to manufacture the clamp. As an example, it is provided that the clamp is made of a plastic material by injection molding. Alternatively, the clamp can also be manufactured using a generative plastic molding process or as a stamped and bent part from a sheet metal.

Preferably, it is provided that a first distance between the first end regions of the two blades and a second distance between the second end regions of the two blades are greater than a distance between the two blades in a central region between the first end region and the second end region. This results in the essentially band-shaped blades lying opposite each other with convexly shaped side surfaces and that, in the case of application for the clamp, forces directed radially and in opposite directions from the respective blades can be deflected from each other and concavely shaped side surfaces of the two blades can be introduced into the surrounding wood of the log.

In a further development of the invention, it is provided that at least one blade is provided with a centering pin which extends beyond the cutting edge in the cutting direction and which has a centering tip which is tapered in the cutting direction. The at least one centering pin facilitates the driving-in process for the clamp, as the one centering pin, which is assigned to one of the blades, or the several centering pins, which are assigned to one or both blades, have a considerably smaller cross-section compared to the two blades and thus also have to displace less wood in order to ensure at least initial fixation of the clamp to the log. As an example, the centering pin has a conical geometry that tapers with increasing distance from the back surface and results in the centering tip. Alternatively, the centering pin is cylindrical in sections, in particular circular-cylindrical, and tapers conically at the end. In order to be able to ensure that the at least one centering pin first comes into contact with the surface of the log during a driving-in process for the clamp, the at least one centering pin protrudes from the blade along the cutting direction beyond the cutting edge. It is advantageous if at least three centering pins are attached to the clamp, with the centering pins preferably being assigned to the first and/or second end regions of the blades. It is particularly preferred that a total of four centering pins are arranged on the clamp, each of which is assigned to one of the first end region and the second end region of the respective first and second blade. As an example, it is provided that the centering pin is an integral part of the blade so that the centering pin projects symmetrically from the blade transversely to the cutting direction or is integrated into the blade in such a way that it only projects beyond the cutting edge in the cutting direction but not in other spatial directions.

In a further embodiment of the invention, it is provided that the centering pin is arranged transversely to the cutting direction adjacent to the blade and/or that the centering pin has, on a rear side facing away from the centering tip, a recess with a geometry which corresponds to a geometry of the centering tip. With such a design of the centering pin, it is advantageous that the centering function of the centering pin is separate from the cutting function of the blade, so that these two components can each be optimally adapted to their intended use. Additionally or alternatively, the centering pin can be provided with a recess on a rear side that is at least largely identical to the tapered area of the centering pin. This favors stackability for the clamp, so that a plurality of such clamps can be accommodated, for example, in a linear arrangement in a magazine, which is designed by its intended purpose for accommodating wooden marking plates. Preferably, when several clamps are arranged in a row, the centering pins of a preceding clamp contact the subsequent clamp and engage in the recesses of the centering pin of the subsequent clamp in such a way that a stable stacking connection is created between the clamps.

In an advantageous further development of the invention, it is provided that the centering pin is designed as an extension of the blade extending in the cutting direction. The centering pin thus forms an extension that is directly associated with the blade and can also be described as a projection of the blade in the cutting direction. The centering pin is thus supported centrally on the blade so that undesirable transverse forces, which have to be transferred from the centering pin to the blade, can be avoided when the clamp is driven into a log. Rather, this arrangement of the centering pin ensures a straight force flow from the back surface of the blade via the blade body into the centering pin.

It is expedient if the two blades are aligned mirror-symmetrically to each other, whereby a mirror plane for the two blades is aligned normal to a minimum distance between the two blades. This is intended to achieve a homogenous deformation behavior for the clamp. This is based on the consideration that the clamp is ideally driven into a wooden log relative to a crack in such a way that the minimum distance between the two blades is parallel to the crack and preferably arranged directly above the crack and the first and second end regions of the blades are arranged at a maximum distance from the crack. It is preferably provided that the minimum distance between the blades is smaller than an extension of the respective blade between the back surface and the cutting edge, in particular in a range between 60 percent and 90 percent of the extension of the respective blade.

In an advantageous further development of the invention, it is provided that the two blades are each provided with a transverse blade at the first end region and/or at the second end region, wherein a transverse blade cutting edge of the transverse blade is aligned at an angle of 70 degrees to 110 degrees to the cutting edge of the blade. The task of the transverse blade is to prevent the associated blade from slipping, as can occur with increasing cracking forces in the log. In this case, the transverse blade forms a barb with which forces that, for example, point from the first end region of the blade towards the second end region of the blade can be intercepted by directing them in the log. Preferably, a length of the transverse blade cutting edge is significantly shorter than a length of the cutting edge. The transverse blade can be designed in such a way that the transverse blade cutting edge is at the same level as the cutting edge of the blade. Alternatively, it may be provided that the transverse blade projects beyond the cutting edge of the blade in the cutting direction, thus ensuring a function similar to the function of the centering pin.

In a further embodiment of the invention, it is provided that the first connecting bar and the second connecting bar are each arcuate in shape, with opposing end regions of the first connecting bar and opposing end regions of the second connecting bar each being aligned normal to convexly shaped inner surfaces of the two blades. The arcuate shape for the first connecting bar and the second connecting bar and the alignment of the respective end regions of the two connecting bars relative to the convexly shaped inner surfaces of the two blades favor advantageous deformation of the blades when in use. It is assumed here that the clamp spans a crack and that a distance between the first end regions of the blades and the second end regions of the blades increases when the crack expands, resulting in a stretching or straightening of the arc-shaped blades. The curved connecting bars counteract this stretching or straightening, as the force flow acts on the inner surfaces in a normal direction via the connecting bars.

It is particularly advantageous if the first connecting bar and the second connecting bar are arranged on a common oval, which means that the first connecting bar and the second connecting bar may be projected to the same oval geometry.

It is preferable that the first connecting bar has a first support plate and that the second connecting bar has a second support plate, wherein the first support plate and the second support plate together with the back surface of the two blades form an, in particular flat, impact surface. The first support plate and the second support plate each extend from the first connecting bar or the second connecting bar and are designed for a large-area introduction of impact forces, which are introduced onto the back surfaces of the blades and the two support plates with a hammer, in particular a marking hammer designed for use with wood marking plates, in order to drive the clamp into the log, wherein the hammers serves as a setting tool.

It is useful if projections projecting outwards in a radial direction are formed on the concave inner surfaces of the blades. The purpose of the projections is to prevent the blades from slipping in the surrounding wood. It is preferable for the projections to each have a triangular profile in a cross-sectional plane aligned transversely to the cutting direction, with a first triangular side of the profile being aligned parallel to the inner surface and a second triangular side of the profile forming an angle at an interval of 45 to 90 degrees with the inner surface. As a result, the projections are designed as undercuts or barbs to prevent slipping in the wood and thus ensure a particularly secure hold of the respective blade in the wood.

In a preferred embodiment of the invention, it is provided that the first end regions of the two blades and the second end regions of the two blades are each provided with retaining tongues projecting from the back surface in the opposite direction to the cutting direction, wherein inner surfaces of mutually opposite retaining tongues are each provided with a concave recess. The retaining tongues serve to positively hold the clamp on a marking hammer, which is designed for use with wooden marking plates. For this purpose, the retaining tongues are designed in the same way as the corresponding retaining tongues of known wooden marking plates. Preferably, the marking hammer has a circular cylindrical hammer head with a flat striking surface and, adjacent to the striking surface, a circumferential groove is formed on the cylindrical outer circumferential surface of the hammer head, into which the retaining tongues can engage with radially inwardly projecting end sections.

### BRIEF DESCRIPTION OF DRAWINGS

Advantageous embodiments of the invention are shown in the drawing. It shows:

FIG. 1 a perspective view of a first embodiment of a clamp as seen from above,

FIG. 2 is a perspective view of the clamp according to FIG. 1 from below,

FIG. 3 a top view of the clamp according to FIGS. 1 and 2,

FIG. 4 a view from below of the clamp according to FIGS. 1 to 4,

FIG. 5 a top view of a second embodiment of a clamp, and

FIG. 6 a perspective view from below of a third embodiment of a clamp.

### DETAILED DESCRIPTION OF INVENTION

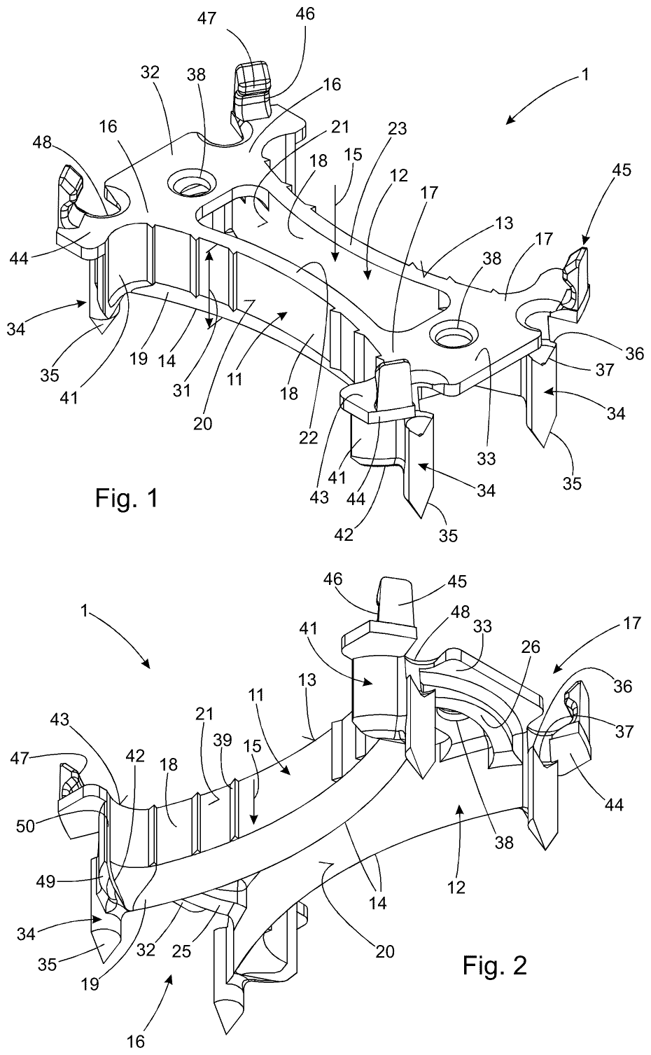

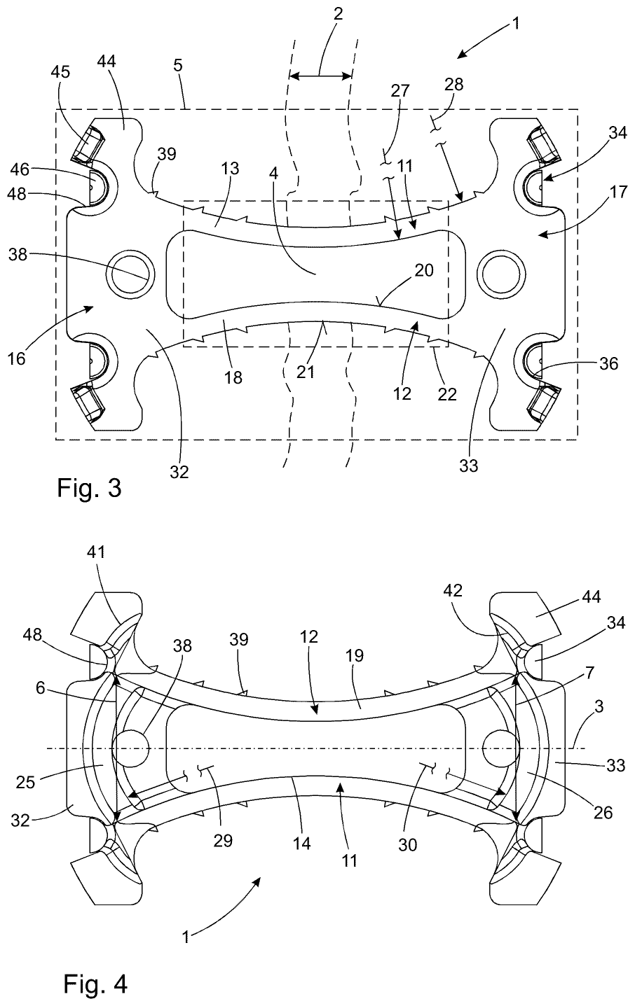

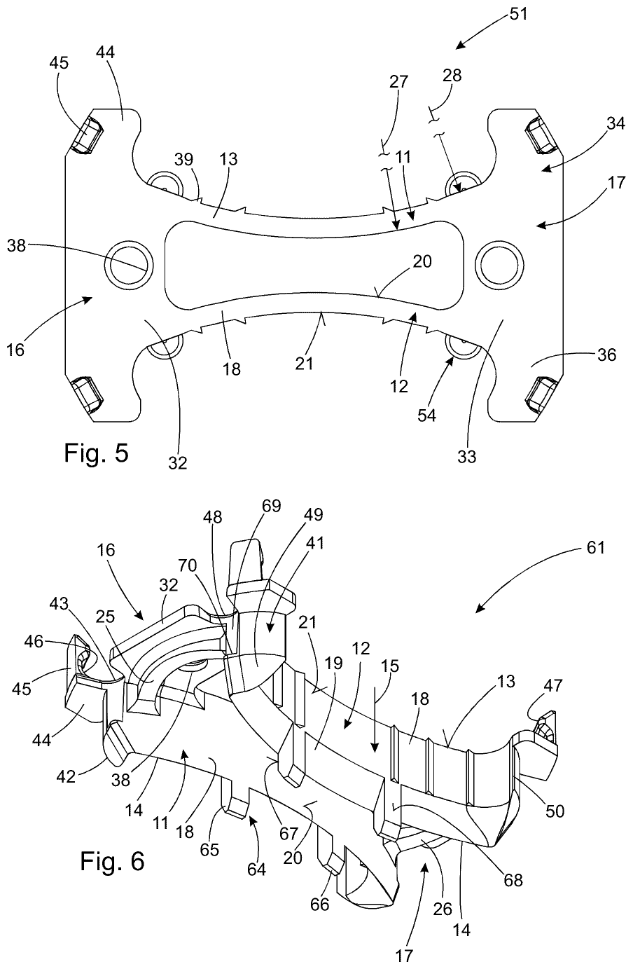

A first embodiment of a clamp 1 shown in FIGS. 1 to 4 is intended, in the same way as a second embodiment of a clamp 51 shown in FIG. 5, to be driven into a cut surface of a log in order either to prevent an already existing crack from expanding further or to prevent cracking at a crack-prone point. An orientation of the clamp 1, which can also be selected for the clamp 51, can be seen in the schematic representation in FIG. 3, in which an existing crack 2 is indicated purely schematically.

The clamp 1 and the clamp 51 are preferably made from a plastic material, in particular in a plastic injection molding process.

The following description of the clamp 1 applies to the clamp 51 in the same way, except for the arrangement of centering pins, so that the properties of the clamp 51 are not described again.

The clamp 1 comprises a first blade 11 and a second blade 12, which are arranged mirror-symmetrical to each other. A mirror plane 3 is drawn in FIG. 4 and is aligned normal to a minimum distance 4 between the first blade 11 and the second blade 12. The minimum distance 4 is smaller than a first distance 6 between the first end regions 16 of the two blades 11, 12 and smaller than a second distance 7 between the second end regions 17 of the two blades 11, 12. Each of the blades 11, 12 comprises a band-shaped blade body 18, which extends with a constant profile from a back surface 13 of the respective blade 11, 12 in a cutting direction 15 to a tapering region 19. In the tapering region 19, the respective blade 11, 12 tapers from the blade body 18 to a cutting edge 14. By way of example only, the blades 11, 12 are tapered exclusively from an inner surface 20 of the blade 11, 12, while an outer surface 21 of the respective blade 11, 12 is formed in a straight extension of the blade body 18 and therefore can be described as a curved strip surface.

By way of example only, both blades 11, 12 have a curvature in a cross-sectional plane 5 which is aligned parallel to the plane of representation of FIG. 3. The curvatures of the concave inner surface 20 and the convex outer surface 21 of the respective blade 11, 12 are preferably matched to each other in such a way that the inner surface 20 and the outer surface 21 are aligned parallel to each other at least in certain areas, in particular over their entire extent. As an example, it is provided that the curvatures of the inner surface 20 and the outer surface 21 each follow circular sections and thus each have a constant radius of curvature 27, 28.

The two blades 11, 12 are connected to each other at a first end region 16 with a first connecting bar 25 and at a second end region 17 with a second connecting bar 26. By way of example, it is provided that the first connecting bar 25 follows a circular section and has a first radius of curvature 29 and that the second connecting bar 26 follows a circular section and has a second radius of curvature 30, which corresponds purely by way of example to the first radius of curvature 29. Preferably, the two radii of curvature 29, 30 are matched to the radius of curvature 27 of the inner surface 20 in such a way that the two connecting bars 25 and 26 each meet the respective inner surfaces 20 of the blades 11, 12 in a normal direction. As an alternative to alignment with a circular section, it may also be provided that the two connecting bars 25, 26 are formed as sections of an oval.

As an example, the connecting bars 25, 26 are each assigned carrier plates 32, 33 formed as plane-parallel plates. These support plates 32, 33 extend parallel to a non-depicted impact surface defined by the back surfaces 13 of the two blades 11, 12 and, like the connecting bars 25, 26, serve to connect the two blades 11, 12. Each of the two support plates 32, 33 has a guide hole 38 passing through it, so that the clamp 1 can be threaded for storage purposes with further, non-depicted clamps onto guide mandrels, which are also not shown.

Each of the two blades 11, 12 is provided with a transverse blade 41 both at the first end region 16 and at the second end region 17. As an example, the transverse blade 41 protrudes at a right angle to the first end region 16 or to the second end region 17 of the respective blade 11, 12. Accordingly, a transverse cutting edge 42 is also aligned at a right angle to the cutting edge 14. By way of example, the transverse blade 41 is tapered on both sides in the cutting direction 15, whereby an angle of a transverse blade outer surface 49 relative to the cutting direction 15 can be selected to be greater than an angle of a transverse blade inner surface 50 relative to the cutting direction 15. The transverse blade 41 forms a thickening at the end for the blade 11, 12, this thickening in the manner of an anchor enabling a tensile force to be introduced into the clamp 1 for tensile forces which are oriented in the direction of a distance between the first connecting bar 25 and the second connecting bar 26 and preferably transversely to a crack direction of a crack to be bounded in a log.

Adjacent to a back surface 43 of the transverse blade 41 extends a plate-shaped support section 44, from which a retaining tongue 45 projects in a direction opposite to the cutting direction 15. Each of the retaining tongues 45 is provided with a recess 46 to form a retaining projection 47. The four retaining tongues 45, by way of example only, allow the clamp 1 to be clipped positively onto a marking hammer with which the driving-in process for the clamp 1 can be carried out.

Six projections 39 are formed on the inner surface 20 of the blades 11, 12, each projecting inwards in a radial direction, which have a triangular profile as shown in FIGS. 3 and 4. The projections 39 serve in the same way as the transverse blades 41 to prevent movement of the respective blade 11, 12 in a direction tangential to the outer surface 21.

As an example, each of the transverse blades 41 is assigned a centering pin 34, which extends in the cutting direction 15 over the cutting edge 14 of the respective blade 11, 12 and has a centering tip 35 at the end. By way of example only, a recess 37 is formed on a rear side 36 of the centering pin 34 facing away from the centering tip 34, the geometry of this recess 37 is adapted to the geometry of the centering tip 35. Furthermore, a recess 48 is formed between the respective carrier plate 32, 33 and the carrier sections 44 associated with the transverse blade 41, so that when several clamps 1 are lined up along the cutting direction 15, the centering pins 34 of a preceding clamp 1 can be received in the recesses 37 of the subsequent clamp 1. As can be seen, for example, from the illustrations in FIGS. 1 and 2, the centering pins 34 are each designed as half-cut off rotational bodies, with an axis of rotation of the centering pin 34, which is not shown in detail, being aligned parallel to the cutting direction 15.

Purely by way of example, the two blades 11, 12 are each freely movable in a central section 22, as they are each connected to one another only at their first and second end regions 16, 17. Preferably, an extension of the first carrier plate 32 and the second carrier plate 33 along the cutting edge 14 is smaller than an extension of the respective middle sections 22.

As an example, it is provided that the radius of curvature 27 of the inner surface 20 and the radius of curvature 28 of the outer surface 28 is 5 to 10 times a distance 31 between the back surface 16 and the cutting edge 14.

The second embodiment of a clamp 51 shown in FIG. 5 differs from the first embodiment of the clamp 1, as shown in FIGS. 1 to 4, in the arrangement of the centering pins 54, which, in contrast to the clamp 1, are not arranged on the transverse blades 41 but directly on the two blades 11, 12.

The embodiment of a clamp 61 shown in FIG. 6 is a variant of the second embodiment of the clamp 51 as shown in FIG. 5. In the clamp 61, the centering pins 64 are arranged away from the transverse blades 41 in the same way as in the clamp 51.

In contrast to the clamp 51, the centering pins 64 are formed as extensions of the blades 11, 12 and extend along the cutting direction 15. By way of example, the centering pins 64 have a rectangular, in particular a square, cross-section in a cross-sectional plane, which cross-sectional plane is aligned transversely to the cutting direction 14.

By way of example, each of the centering pins 64 is provided with a centering cutting edge 65 that is symmetrically wedge-shaped and tapered in the cutting direction at an end region facing away from the blade 11 or 12. Alternatively, in an embodiment not shown, the respective centering pin can have an asymmetrical wedge shape, in particular a wedge shape on one side only like the blade 11, 12.

A cutting edge 66 of the centering blade 65 is aligned parallel to the cutting edge 14 of the respective blade 11, 12. This can prevent undesirable torsional stresses from being caused in the blades 11, 12 and in the log after penetration of the centering pins 64 into the log to be stabilized during subsequent penetration of the blades 11, 12 into the log, as could be the case if the cutting edges 66 of the centering pins 64 were not aligned parallel to the cutting edges 14 of the blades 11, 12.

Furthermore, in the embodiment according to FIG. 6, purely by way of example, it is provided that an inner surface 67 of the centering pin 64 is formed flush with the inner surface 20 of the blade 11 or 12. In addition, purely by way of example, it is provided that an outer surface 68 of the centering pin 64 is formed flush with the outer surface 21 of the blade 11 or 12. This ensures that the centering pins 64, in a state in which the clamp 61 is driven into the log as intended, have the same profiling as the blades 11, 12 in a cross-sectional plane aligned transversely to the cutting direction 14, which favors the penetration process for the clamp 61 into the log. In other words, the arrangement and design of the centering pins 64 ensures that a projection of the centering pins 64 onto a projection plane aligned transversely to the cutting direction, which corresponds to the cross-sectional plane 5 according to FIG. 3, is in overlap with a projection of the respective blade 11 or 12.

Due to the arrangement of the centering pins 64 in extension of the blade 11 or 12, an advantageous flow of force within the clamp 61 is ensured during the impact process for the clamp. Purely by way of example, it is assumed that an impact process for the clamp 61 is carried out with a marking hammer which is designed for processing wooden marking plates and has, by way of example, a hammer head of circular cylindrical design, which is provided with a circumferential annular groove, into which the retaining projections 47 of the retaining tongues 45 can engage in a form-fitting manner. A flat end face of the marking hammer lies at least essentially flat against the back surfaces 13 of the blades 11, 12. If the marking hammer with the clamp 61 held on it is now accelerated in the course of an impact movement and the clamp 61 with the centering pins 64 hits the at least essentially flat end face of the log, a force is transmitted between the marking hammer, the clamp 61 and the log. This results in an essentially straight force flow from the back surface 13 through the blades 11, 12 into the centering pins 64. Undesirable tilting forces due to blade areas aligned at an angle to each other, which would lead to an increase in the driving forces required to drive the clamp 61 into the log, are thus avoided.

In the embodiment of the clamp 61 shown in FIG. 6, a concave curved profile surface 69 extends from the recess 48 to a transverse blade edge step 70, in particular in the cutting direction 15. The transverse blade edge step 70 projects transversely to the cutting direction from the profile surface 69 and forms an undercut against the cutting direction 15. Thus, the transverse blade edge step 70 reduces the risk of the clamp 61 working its way out of the not shown log against the cutting direction 15, for example due to temperature fluctuations and associated different expansion changes of the clamp 61 and the log.

In a further, not shown embodiment of a clamp, the transverse blades project beyond the cutting edges of the blades in the cutting direction and can thus also fulfill a function as centering elements, whereby in this case separately formed centering pins are not necessary.

1. A clamp for limiting cracks in logs, having two blades which each extend from a back surface to a cutting edge along a cutting direction and which are tapered in the cutting direction, the cutting directions of the two blades are aligned parallel to one another and wherein the two blades are connected by a first connecting bar which extends between first end regions of the two blades and by a second connecting bar which extends between second end regions of the two blades.

2. The clamp according to claim 1, wherein the first connecting bar and the second connecting bar each extend between the back surfaces of the two blades.

3. The clamp according to claim 1, wherein the two blades have a curvature with a radius of curvature which is 5 times to 10 times greater than a distance between the back surface and the cutting edge in a cross-sectional plane aligned transversely to the cutting direction.

4. The clamp according to claim 1, wherein a first distance between the first end regions of the two blades and a second distance between the second end regions of the two blades both are greater than a distance between the two blades in a central region between the first end region and the second end region.

5. The clamp according to claim 1, wherein at least one blade is provided with a centering pin which extends beyond the cutting edge in the cutting direction and which has a centering tip which is tapered in the cutting direction.

6. The clamp according to claim 5, wherein the centering pin is arranged transversely to the cutting direction adjacent to the blade and/or wherein the centering pin has, on a rear side facing away from the centering tip, a depression with a geometry which corresponds to a geometry of the centering tip.

7. The clamp according to claim 5, wherein the centering pin is designed as an extension of the blade extending in the cutting direction.

8. The clamp according to claim 1, wherein the two blades are aligned mirror-symmetrically with respect to one another, a mirror plane for the two blades being aligned normal to a minimum distance between the two blades.

9. The clamp according to claim 1, wherein the two blades are each provided at the first end region and/or at the second end region with a transverse blade, wherein a transverse blade cutting edge of the transverse blade is aligned at an angle of between 70 degrees and 110 degrees to the cutting edge.

10. The clamp according to claim 1, wherein the first connecting bar and the second connecting bar are each of arcuate design, with mutually opposite end regions of the first connecting bar and mutually opposite end regions of the second connecting bar each being aligned normal to convexly shaped inner surfaces of the two blades.

11. The clamp according to claim 10, wherein the first connecting bar and the second connecting bar are arranged on a common oval.

12. The clamp according to claim 10, wherein the first connecting bar has a first carrier plate and wherein the second connecting bar has a second carrier plate and wherein the first carrier plate and the second carrier plate and the back surface of the two blades form an impact surface.

13. The clamp according to claim 1, wherein projections projecting outwards in the radial direction are formed on concave inner surfaces of the blades.

14. The clamp according to claim 13, wherein the projections each have a triangular profiling in a cross-sectional plane aligned transversely to the cutting direction, a first triangular side of the profiling being aligned parallel to the inner surface and a second triangular side of the profiling enclosing an angle in an interval of 45 to 90 degrees with the inner surface.

15. The clamp according to claim 1, wherein the first end regions of the two blades and the second end regions of the two blades are each formed with retaining tongues projecting from the back surface in the direction opposite to the cutting direction, wherein inner surfaces of mutually opposite retaining tongues each being provided with a concave recess.
